(19) United States
(12) Patent Application Publication
(10) Pub. No.: US 2025/0112301 A1
(43) Pub. Date: Apr. 3, 2025

(54) BATTERY

(71) Applicant: MURATA MANUFACTURING CO., LTD., Kyoto (JP)

(72) Inventor: Kunio SODEYAMA, Nagaokakyo-shi (JP)

(21) Appl. No.: 18/896,498

(22) Filed: Sep. 25, 2024

(30) Foreign Application Priority Data
Sep. 28, 2023 (JP) 2023-167758

(51) Int. Cl. H01M 50/107; H01M 50/533

(52) U.S. Cl. CPC H01M 50/107; H01M 50/533

(57) ABSTRACT

A battery is provided and including a battery element having a first outer end surface and a second outer end surface; and an exterior body having a cylindrical shape, having a first inner end surface to face the first outer end surface, and housing the battery element, in which the exterior body has a first inner diameter φ₁ at a position 4 mm distant from the first inner end surface toward the second outer end surface; the exterior body has a second inner diameter φ₂ at a position 7 mm distant from the second outer end surface of the battery element toward the first outer end surface; and the first inner diameter φ₁ is 0.24 to 0.72% smaller than the second inner diameter φ₂.

### CROSS REFERENCE TO RELATED APPLICATION

The present application claims the benefit of Japanese Application No. 2023-167758 titled “BATTERY” and filed on Sep. 28, 2023, the contents of which is incorporated by reference herein in its entirety.

### BACKGROUND

The present disclosure relates to a battery.

Batteries are capable of extracting energy due to chemical change or the like as electric energy, and used for various applications. For example, batteries are used in mobile devices such as mobile phones, smart phones, and notebook computers.

Conventionally, a battery can (exterior body) of such a battery is formed from a metal plate by, for example, a drawing/ironing process (deep drawing process).

### SUMMARY

The present disclosure relates to a battery.

The battery as described in the Background section cannot sufficiently improve vibration resistance.

The present disclosure, in an embodiment, relates to providing a battery having further improved vibration resistance.

The battery of an embodiment of the present disclosure includes:
a battery element having a first outer end surface and a second outer end surface; and an exterior body having a cylindrical shape, having a first inner end surface to face the first outer end surface, and housing the battery element,
in which the exterior body has a first inner diameter φ₁ at a position 4 mm distant from the first inner end surface toward the second outer end surface; the exterior body has a second inner diameter φ₂ at a position 7 mm distant from the second outer end surface of the battery element toward the first outer end surface; and the first inner diameter φ₁ is 0.24 to 0.72% smaller than the second inner diameter φ₂.

The battery of an embodiment of the present disclosure can provide a battery having further improved vibration resistance.

### BRIEF DESCRIPTION OF THE FIGURES

FIG. 1 is a schematic perspective view illustrating the appearance of a battery according to an embodiment of the present disclosure;

FIG. 2 is a schematic view illustrating the internal configuration of a battery according to an embodiment of the present disclosure;

FIG. 3 is a sectional view illustrating a battery according to an embodiment of the present disclosure;

FIG. 4 is a sectional view illustrating a battery element and an exterior body in a battery according to an embodiment of the present disclosure;

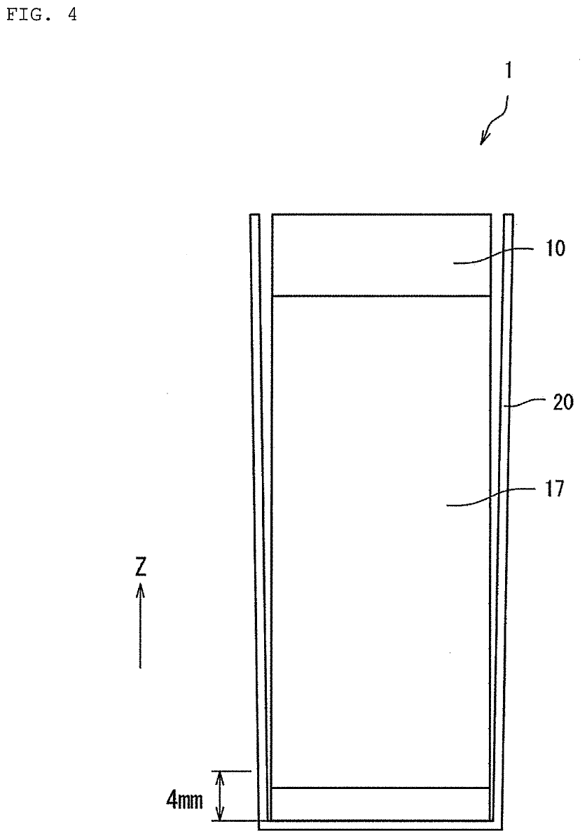

FIG. 5 is a sectional view illustrating a punch and an exterior body in deep drawing;

FIG. 6 is a sectional view illustrating a battery according to an embodiment of the present disclosure;

FIG. 7 is a schematic view illustrating a battery element in a battery according to an embodiment of the present disclosure;

FIG. 8 is an enlarged sectional view of the vicinity of the end of a battery element in a battery according to an embodiment of the present disclosure; and

FIG. 9 is a sectional view illustrating a battery element and an exterior body in a battery according to an embodiment of the present disclosure.

### DETAILED DESCRIPTION

The present disclosure will be described in further detail according to an embodiment. It should be noted that the following description and examples for those skilled in the art to fully understand the present disclosure, and these are not intended to limit the present disclosure. That is, the present disclosure is not particularly limited to the preferred embodiments and the like described below, and can be appropriately modified. Note that, in consideration of the description of the main points or ease of understanding, the present disclosure may be explained by being divided into embodiments, examples, and the like, for convenience, but partial replacement and/or combination of configurations illustrated in different embodiments and the like are possible. In the description of such an embodiment, redundant description of substantially the same matters may be omitted, and only different points may be described. In particular, similar functions and effects made by similar configurations are sometimes not be sequentially mentioned for each embodiment.

Furthermore, in the description in the present specification, reference to a direction, an orientation, or the like is merely for convenience of description, and is not intended to limit the scope of the present disclosure unless otherwise explicitly described. For example, relative terms such as “Outer (or outer side, outer part, or outer peripheral)” and “Inner (or inner side, inner part, or inner peripheral)” and derived terms thereof should be understood to refer to directions described or illustrated. Similarly, “on” an element includes not only a case of being in contact with the upper surface of the element but also a case of not being in contact with the upper surface of the element. That is, “on” an element includes not only an upper position away from the element, that is, an upper position via another object on the element or an upper position spaced apart from the element, but also an immediately above position in contact with the element. In addition, the term “on” does not necessarily mean the upper side in the vertical direction. The term “on” merely indicates a relative positional relationship of certain elements. That is, unless otherwise explicitly described, the disclosure is not limited only to a specific direction, orientation, form, or the like. In addition, the same applies to terms such as “provided”, “arranged”, and “connected”, and derived terms thereof. Unless otherwise explicitly described, the terms are not limited to a direct mode, and may be a mode in which another element such as an intervening object is interposed.

The various numerical ranges mentioned in the present specification are intended to include the lower and upper limit numerical values themselves unless otherwise specified, for example, by “less than”. More specifically, for example, it is interpreted that a numerical range such as 0.24 to 0.72% includes the lower limit value 0.24% and also includes the upper limit value 0.72%.

The term “battery” in the present specification includes not only a so-called “secondary battery” but also a “primary battery”, which is capable of only discharging. That is, the “battery” in the present specification may be a “secondary battery”, which can be repeatedly charged and discharged, or a “primary battery”, which is substantially only discharged. The “secondary battery” is not excessively limited by its name, and for example, “power storage devices” and the like can also be included in the subject.

Hereinafter, the “battery” of an embodiment of the present disclosure will be described in detail. While the description is made with reference to the drawings as necessary, the contents shown in the drawings are only schematically and illustratively shown for understanding the present disclosure, and the appearance, the dimensional ratio, and the like can be different from the actual ones. For example, the characteristic portions in the embodiments of the present disclosure may be emphasized.

Hereinafter, for convenience of description, the battery of the present disclosure will be described by taking a secondary battery as an example.

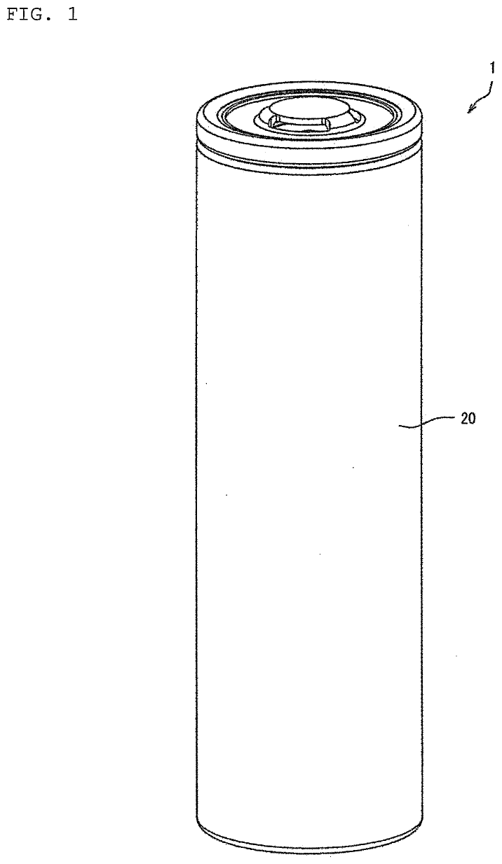

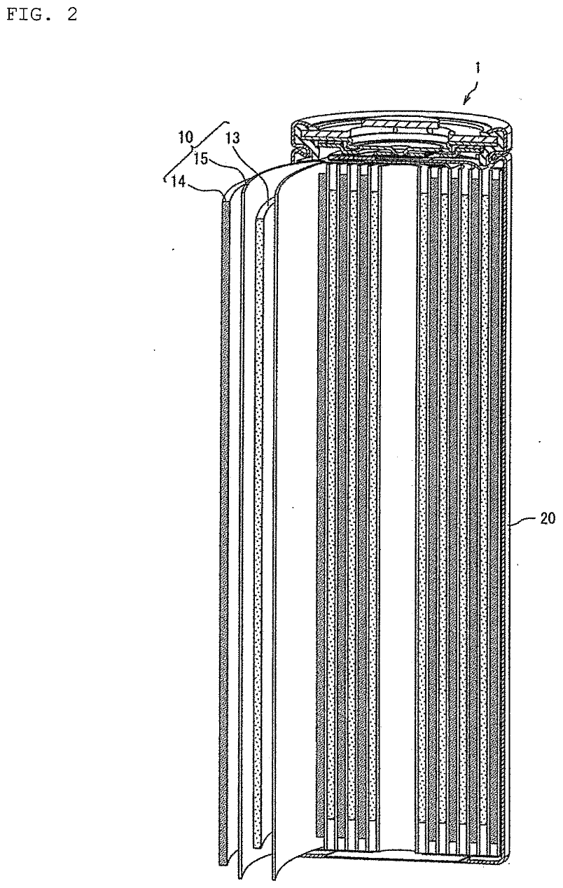

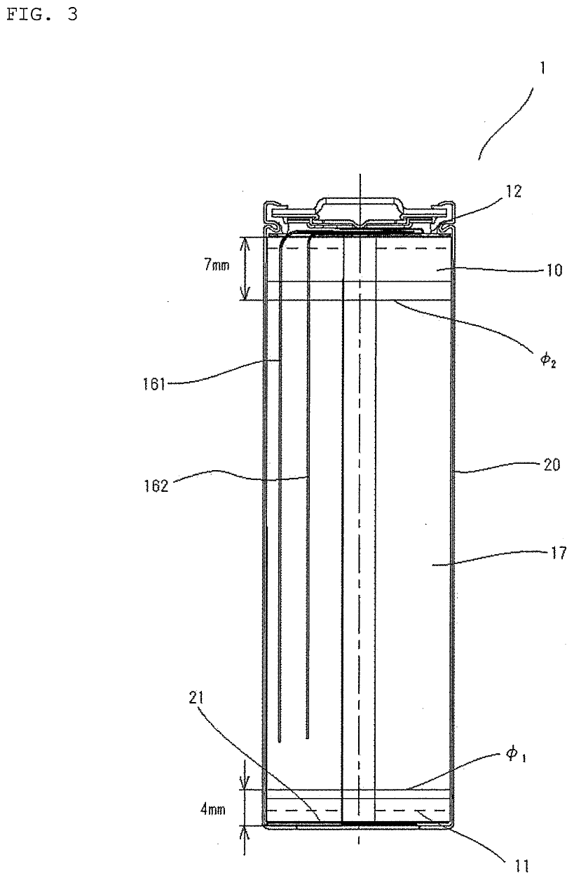

The present disclosure relates to a battery (secondary battery) 1 according to a first embodiment. The battery of the first embodiment will be described with reference mainly to FIGS. 1, 2, and 3. FIG. 1 is a schematic perspective view illustrating the appearance of the battery of the first embodiment. FIG. 2 is a schematic view illustrating the internal configuration of the battery of the first embodiment. FIG. 3 is a sectional view illustrating the battery of the first embodiment. In FIGS. 1 to 3, the direction parallel to the axial direction (battery axial direction) of the battery 1 is defined as the Z direction, the vertically downward direction is defined as the reverse Z direction, and the vertically upward direction is defined as the forward Z direction. In the present specification, the battery axis corresponds to the central axis of the battery 1 having a cylindrical shape. In FIGS. 1 to 3, the reference sign “first” is attached to a member arranged on the lower side (reverse Z direction side), and the reference sign “second” is attached to a member arranged on the upper side (forward Z direction side).

In the present specification, the cylindrical shape means that a cylinder has a large ratio (aspect ratio) of the height to the equivalent circle diameter of the bottom surface (for example, an aspect ratio of 1 or more). Here, the equivalent circle diameter of a bottom surface refers to the diameter of a circle having an area equal to the area of the bottom surface.

As illustrated in FIGS. 1 to 3, the secondary battery 1 of the first embodiment includes: a battery element (electrode assembly) 10 having a first outer end surface 11 and a second outer end surface 12; and an exterior body (battery can) 20 having a cylindrical shape, having a first inner end surface 21 to face the first outer end surface 11, and housing the battery element 10. The secondary battery 1 further includes an electrolyte (not illustrated) sealed in the exterior body 20.

In the first embodiment, the battery 1 has further improved vibration resistance.

As illustrated in FIG. 3, the exterior body 20 has a first inner diameter φ₁ at a position 4 mm distant from the first inner end surface 21 toward the second outer end surface 12; the exterior body 20 has a second inner diameter φ₂ at a position 7 mm distant from the second outer end surface 12 of the battery element 10 toward the first outer end surface 11; and the first inner diameter φ₁ is 0.24 to 0.72% smaller than the second inner diameter φ₂.

As described above, since the inner diameter ratio [(φ₂−φ₁)/φ₂] is 0.72% or less, the clearance between the inner diameter of the exterior body 20 and the outer surface of the battery element 10 does not largely differ between the first inner diameter φ₁ and the second inner diameter φ₂. In addition, since the inner diameter ratio [(φ₂−φ₁)/φ₂] is 0.24% or more, the clearance between the inner diameter of the exterior body 20 and the outer surface of the battery element 10 is sufficiently small. As a result, the battery element 10 is hardly vibrated in the whole exterior body 20. Therefore, in the first embodiment, the battery 1 has further improved vibration resistance.

Furthermore, in the first embodiment, the battery 1 can have a reduced defective rate in battery production, as well as improved vibration resistance.

The inner diameter of the exterior body 20 decreases along the direction in which the battery element 10 is inserted from the second inner diameter φ₂ side to the first inner diameter φ₁ side in the exterior body 20. Therefore, in the production of the battery 1, the battery element 10 is easily smoothly inserted into the exterior body 20. Therefore, the defective rate can be reduced when the battery 1 is produced.

Therefore, in the first embodiment, the battery 1 can have both “improved vibration resistance” and “reduced defective rate in battery production” conflicting therewith.

The method for calculating the inner diameter ratio of the battery element 10 is as follows. The battery 1 as a finished product is disassembled. The first outer end surface 11 side of the battery element 10 of the battery 1 is opened, and the position of the second outer end surface 12 of the battery element 10 is marked on the inner side surface of the exterior body 20. The exterior body 20 is taken out. A probe of a three-dimensional measuring machine (“Three-dimensional measuring machine” manufactured by Mitutoyo Corporation) is inserted into the exterior body 20, which has been taken out. The inner diameter is measured at predetermined positions (at the position 4 mm distant from the first inner end surface 21 toward the second outer end surface 12 for the first inner diameter φ₁; at the position 7 mm distant from the second outer end surface 12 of the battery element 10 toward the first outer end surface 11 for the second inner diameter φ₂). The inner diameter ratio [(φ₂−φ₁)/φ₂] is calculated from the obtained inner diameters (φ₁ and φ₂).

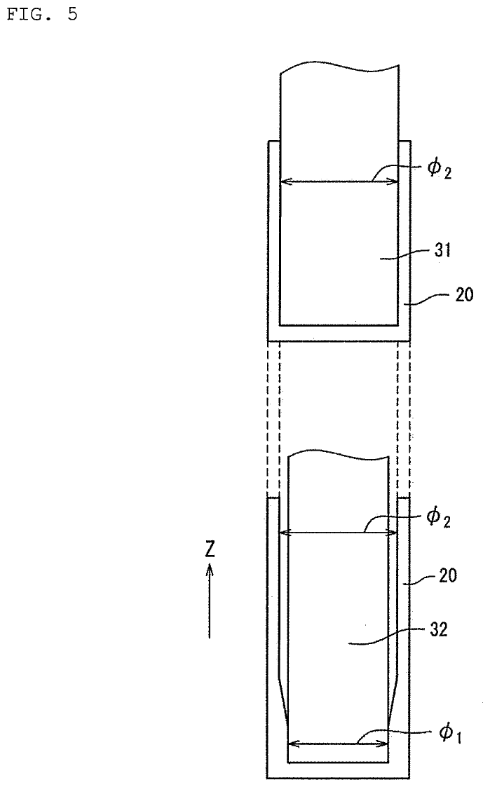

Such an inner diameter ratio of the exterior body 20 can be adjusted, for example, by processing in multiple stages (at least two stages) using punches having different diameters in deep drawing in the method for producing the battery 1. An example thereof will be described with reference to FIG. 5. FIG. 5 is a sectional view illustrating a punch and an exterior body in deep drawing. As illustrated in the upper view of FIG. 5, a metal plate is deep-drawn using a punch 31 having an outer diameter φ₂. As a result, a space having an inner diameter φ₂ is formed inside the exterior body 20. Next, as illustrated in the lower view of FIG. 5, the metal plate is further deep-drawn using a punch 32 having an outer diameter φ₁ (<φ₂). As a result, the exterior body 20 having a predetermined inner diameter ratio [(φ₂−φ₁)/φ₂] therein is produced.

The above description has been made on the basis of the inner diameter ratio, but the description can also be made on the basis of the inner diameter difference.

In a preferred mode, the difference between the first inner diameter φ₁ and the second inner diameter φ₂ (φ₂−φ₁) is 0.05 to 0.15 mm. The difference (φ₂−φ₁) is calculated from the first inner diameter of and the second inner diameter φ₂ measured by the calculation method for the battery element 10. When the difference (φ₂−φ₁) is 0.05 mm or more, the clearance between the inner diameter of the exterior body 20 and the outer surface of the battery element 10 does not largely differ between the first inner diameter φ₁ and the second inner diameter φ₂. In addition, when the difference (φ₂−φ₁) is 0.15 mm or less, the clearance between the inner diameter of the exterior body 20 and the outer surface of the battery element 10 is sufficiently small. As a result, the battery element 10 is hardly vibrated in the whole exterior body 20.

In a preferred mode of the exterior body 20, the inner diameter on the side of the second outer end surface 12 is preferably larger than the inner diameter on the side of the first outer end surface 11 within the range where the inner diameter ratio [(φ₂−φ₁)/φ₂] is 0.24 to 0.72%. In a sectional view parallel to the battery axis, for example, the exterior 11 body 20 has a sectional shape that has at least one shape selected from a group consisting of a curved shape and a linear shape in at least a part of the section. Specific examples of the sectional shape include a trumpet shape consisting of a curved shape. The inner diameter of the exterior body 20 may be partly constant along the battery axis. For example, as illustrated in FIG. 3, the inner diameter of the exterior body 20 may simply increase from the first outer end surface 11 of the battery element 10 toward the second outer end surface 12. Alternatively, as illustrated in the lower view of FIG. 5, the inner diameter of the exterior body 20 may partly simply increase from the first outer end surface 11 of the battery element 10 toward the second outer end surface 12.

As illustrated in FIG. 2, the battery element (electrode assembly) 10 includes an electrode constituting layer including a positive electrode 13, a negative electrode 14, and a separator 15. The battery element 10 further includes an element fixing portion 17 on the outer peripheral surface thereof. The element fixing portion 17 fixes the end of the electrode constituting layer having a wound structure. Accordingly, the element fixing portion 17 prevents loosening or relaxing of the electrode constituting layer.

The element fixing portion 17 is located on the outer surface of the battery element 10. The element fixing portion 17 has a lower end arranged within the 4 mm region from the first inner end surface 21 toward the second outer end surface 12, and an upper end arranged within the 7 mm region from the second outer end surface 12 toward the first outer end surface 11. When viewed from the direction perpendicular to the battery axis, the element fixing portion 17 is arranged at least at the end portion of the electrode constituting layer, and optionally goes around the outer periphery (side peripheral surface) of the battery element 10.

The element fixing portion 17 may swell in the exterior body 20 in the presence of an electrolytic solution to function as a spacer. That is, the element fixing portion 17 fills the clearance between the outer surface of the battery element 10 and the inner surface of the exterior body 20. As a result, the area in contact with the inner surface of the exterior body 20 increases. In addition, the element fixing portion 17 may swell to be viscous, increasing adhesion to the inner surface of the exterior body 20. Therefore, the battery element 10 is further fixed in the exterior body 20, and vibration resistance can be further improved.

Examples of the resin constituting the element fixing portion 17 include a polyurethane resin from the viewpoint of easily swelling in an electrolytic solution and easily having an increased viscosity due to swelling.

As described above, the battery 1 of the first embodiment includes a battery element 10, an exterior body 20 housing the battery element, and an electrolyte (not illustrated). Each member will be described below.

As illustrated in FIG. 2, the battery element (electrode assembly) 10 includes an electrode constituting layer including a positive electrode 13, a negative electrode 14, and a separator 15. The electrode constituting layer may have a roll-shaped wound structure (hereinafter, also referred to as “wound electrode body” or “wound structure”). The electrode assembly 10 has a configuration in which the positive electrode 13, the negative electrode 14, and the separator 15 arranged between the positive electrode 13 and the negative electrode 14 are wound. In the secondary battery 1, such an electrode assembly 10 is enclosed together with an electrolyte (for example, a non-aqueous electrolyte) in the exterior body 20.

The battery element 10 includes a current collector (a positive electrode current collector and a negative electrode current collector), an electrode member layer (a positive electrode material layer and a negative electrode material layer) laminated with the current collector, and an electrode current collector.

The positive electrode 13 includes at least a positive electrode material layer and a positive electrode current collector. In the positive electrode 13, the positive electrode material layer is provided on at least one surface of the positive electrode current collector. The positive electrode material layer contains a positive electrode active material as an electrode active material. For example, for each of a plurality of positive electrodes 13 in the electrode assembly 10, the positive electrode material layer may be provided on both surfaces of the positive electrode current collector, or may be provided only on one surface of the positive electrode current collector.

The negative electrode 14 includes at least a negative electrode material layer and a negative electrode current collector. In the negative electrode 14, the negative electrode material layer is provided on at least one surface of the negative electrode current collector. The negative electrode material layer contains a negative electrode active material as an electrode active material. For example, for each of a plurality of negative electrodes 14 in the electrode assembly 10, the negative electrode material layer may be provided on both surfaces of the negative electrode current collector, or may be provided only on one surface of the negative electrode current collector.

The electrode active materials contained in the positive electrode 13 and the negative electrode 14, that is, the positive electrode active material and the negative electrode active material are materials directly involved in transfer of electrons in the secondary battery, and are main materials of the positive and negative electrodes that are responsible for charge and discharge, that is, the battery reaction. More specifically, ions are brought into the electrolyte due to the “positive electrode active material contained in the positive electrode material layer” and the “negative electrode active material contained in the negative electrode material layer”, and the ions move between the positive electrode 13 and the negative electrode 14 to transfer electrons, and thus charge and discharge is performed. The positive electrode material layer and the negative electrode material layer may be layers particularly capable of occluding and releasing lithium ions. That is, the secondary battery 1 of the first embodiment may be a non-aqueous electrolyte secondary battery, in which lithium ions move between the positive electrode 13 and the negative electrode 14 through the non-aqueous electrolyte to charge and discharge the battery 1. When lithium ions are involved in charge and discharge, the secondary battery 1 of the first embodiment corresponds to a so-called “lithium ion battery”, and includes layers capable of occluding and releasing lithium ions as the positive electrode 13 and the negative electrode 14.

In view of a lithium ion battery, the positive electrode active material may be a material that contributes to occlusion and release of lithium ions. That is, the positive electrode layer may contain any one kind or two or more kinds among positive electrode materials capable of occluding and releasing lithium. From such a viewpoint, the positive electrode active material may be, for example, a lithium-containing compound. The lithium-containing compound is not particularly limited in its type, but may be, for example, a lithium-containing composite oxide, a lithium-containing phosphate compound, or the like. This is because a high energy density can be easily obtained.

The lithium-containing composite oxide is a generic name of oxides containing lithium and one or two or more of other elements (elements other than lithium) as constituent elements, and may have, for example, one of crystal structures such as a layered rock-salt type crystal structure and a spinel type crystal structure. The lithium-containing phosphate 21 compound is a generic name of phosphate compounds that contain lithium and one or two or more of other elements as constituent elements, and may have, for example, a crystal structure such as an olivine crystal structure. The kind of the other elements is not particularly limited as long as the element is any one or two or more of arbitrary elements. Among them, as the other elements, one or two or more of elements belonging to Groups 2 to 15 in the long-period periodic table is preferable. More specific examples of the other elements include nickel (Ni), cobalt (Co), manganese (Mn), and iron (Fe). This is because a high voltage can be easily obtained.

Examples of the lithium-containing composite oxide having a layered rock-salt type crystal structure include compounds each represented by the following formulae (1) to (3).

LiₐMn_{(1-b-c)}Ni_{b}M11_{c}O_{(2-d)}Fₑ (1)

(M11 represents at least one of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W).

“a” to “e” satisfy 0.8≤a≤1.2, 0<b<0.5, 0≤c≤0.5, (b+c)<1, −0.1≤d≤0.2, and 0≤e≤0.1. However, the composition of lithium varies depending on the charged and discharged states, and “a” is a value of a fully discharged state).

LiₐNi_{(1-b)}M12_{b}O_{(2-c)}F_{d} (2)

(M12 is at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.8≤a≤1.2, 0.005≤b≤0.5, −0.1≤c≤0.2, and 0≤d≤0.1. However, the composition of lithium varies depending on the charged and discharged states, and “a” is a value of a fully discharged state).

LiₐCo_{(1-b)}M13_{b}O_{(2-c)}F_{d} (3)

(M13 is at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.8≤a≤1.2, 0≤b<0.5, −0.1≤c≤0.2, and 0≤d≤0.1. However, the composition of lithium varies depending on the charged and discharged states, and “a” is a value of a fully discharged state).

Specific examples of the lithium-containing composite oxide having a layered rock-salt type crystal structure include LiNiO₂, LiCoO₂, LiCO_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

When the lithium-containing composite oxide having a layered rock-salt type crystal structure contains nickel, cobalt, manganese, and aluminum as constituent elements, the atomic ratio of nickel is preferably 50 atomic % or more. This is because a high energy density can be easily obtained.

Examples of the lithium-containing composite oxide having a spinel type crystal structure include a compound represented by the following formula (4).

LiₐMn_{(2-b)}M14_{b}O_{c}F_{d} (4)

(M14 is at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); “a” to “d” satisfy 0.9≤a≤1.1, 0≤b≤0.6, 3.7≤c≤4.1, and 0≤d≤0.1. However, the composition of lithium varies depending on the charged and discharged states, and “a” is a value of a fully discharged state).

Specific examples of the lithium-containing composite oxide having a spinel type crystal structure include LiMn₂O₄.

Examples of the lithium-containing phosphate compound having an olivine type crystal structure include a compound represented by the following formula (5).

LiₐM15PO₄ (5)

(M15 is at least one of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr). “a” satisfies 0.9≤a≤1.1. However, the composition of lithium varies depending on the charged and discharged states, and “a” is a value of a fully discharged state).

Specific examples of the lithium-containing phosphate compound having an olivine type crystal structure include LiFePO₄, LiMnPO₄, LiFe_{0.5}Mn_{0.5}PO₄, and LiFe_{0.3}Mn_{0.7}PO₄.

Incidentally, the lithium-containing composite oxide may be a compound represented by the following formula (6).

(Li₂MnO₃)ₓ(LiMnO₂)₁₋ₓ (6)

(“x” satisfies 0≤x≤1. However, the composition of lithium varies depending on the charged and discharged states, and “x” is a value of a fully discharged state).

In addition, for example, the positive electrode material may be any one kind or two or more kinds among oxides, disulfides, chalcogenides, and conductive polymers. Examples of the oxide include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and may be a material other than the above materials.

The positive electrode material layer may contain a binder. Furthermore, the positive electrode material layer May contain a positive electrode conductive agent in order to facilitate electron transfer promoting the battery reaction. The positive electrode binder may contain, for example, any one or two or more types of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent includes, for example, any one or two or more of carbon materials. The carbon material may be, for example, graphite, carbon black, acetylene black, ketjen black, or the like. However, the positive electrode conductive agent may be a metal material, a conductive polymer, and the like, as long as it is a material exhibiting conductivity.

Similarly, the negative electrode active material of the negative electrode material layer may be a material that contributes to occlusion and release of lithium ions. That is, the negative electrode layer may contain any one kind or two or more kinds among negative electrode materials capable of occluding and releasing lithium. From such a viewpoint, the negative electrode active material may be, for example, various carbon materials, metal-based materials, and/or other materials.

When the carbon material is used as the negative electrode active material, the crystal structure shows a very small change when lithium is occluded and released, so that a high energy density can be easily and stably obtained. Further, the carbon material also functions as a negative electrode conductive agent, so that the negative electrode layer easily has an improved conductivity.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at an appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic term for materials containing any one kind or two or more kinds among metal elements and metalloid elements as constituent elements. When the metal-based material is used as the negative electrode active material, a high energy density can be easily obtained. The metal-based material may be a single metal, an alloy, a compound, two or more of these, or a material at least a part of which has one or two or more of these phases. However, the alloy includes a material containing one or more kinds of metal elements and one or more kinds of metalloid elements in addition to a material composed of two or more kinds of metal elements. The alloy may also contain a non-metallic element. The construction of this metal-based material may be, for example, a solid solution, a eutectic (eutectic mixture), an intermetallic compound, and a material in which two or more kinds among these coexist. The metal element and metalloid element described above may be, for example, any one kind or two or more kinds among metal elements and metalloid elements capable of forming an alloy with lithium. Specific examples of the metal element and the metalloid element include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and/or platinum (Pt). In a preferred embodiment, the metal element is silicon and tin. This is because the ability to occlude and release lithium is excellent and thus a higher energy density can be easily obtained. The material containing silicon as a constituent element may be a simple substance of silicon, an alloy of silicon, or a compound of silicon, may be two or more thereof, or may be a material at least a part of which has one or two or more of these phases. Similarly, the material containing tin as a constituent element may be a simple substance of tin, an alloy of tin, or a compound of tin, may be two or more thereof, or may be a material at least a part of which has one or two or more of these phases. The “simple substance” described here is a simple substance in a general sense to the utmost, and thus the simple substance May contain a small amount of impurities. That is, the purity of the single substance is not necessarily limited to 100%. The alloy of silicon contains, for example, any one or two or more of tin, nickel, copper, iron, cobalt, manganese, zinc, indium, silver, titanium, germanium, bismuth, antimony, chromium, and the like as constituent elements other than silicon. The compound of silicon contains, for example, any one or two or more of carbon, oxygen, and the like as constituent elements other than silicon. The compound of silicon may contain, for example, any one or two or more of a series of elements described in the alloy of silicon as constituent elements other than silicon. Specific examples of the alloy of silicon and the compound of silicon include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), and/or LiSiO. In SiOᵥ, “v” may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more types of carbon, oxygen, and the like, as constituent elements other than tin. The compound of tin may contain any one or two or more of a series of elements described in the alloy of tin, for example, as constituent elements other than tin. Specific examples of the alloy of tin and the compound of tin include SnO_{w} (0<w≤2), SnSiO₃, LiSnO, and/or Mg₂Sn. Particularly, the material containing tin as a constituent element may be, for example, a material containing a second constituent element and a third constituent element together with tin, which is a first constituent element (tin-containing material). The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one or two or more of boron, carbon, aluminum, phosphorus, and the like. This is because a high battery capacity, excellent cycle characteristics, and the like can be easily obtained. Among these, the tin-containing material may be a material containing tin, cobalt, and carbon as constituent elements (tin cobalt carbon-containing material). This is because a high energy density can be easily obtained. In the tin cobalt carbon-containing material, at least a part of carbon as a constituent element may be bonded to a metal element or metalloid element as other constituent elements. This is because the aggregation of tin, crystallization of tin, and the like are easily suppressed. The tin cobalt carbon-containing material is not limited to a material that contains only tin, cobalt, and carbon as constituent elements (SnCoC). This tin cobalt carbon-containing material may further contain, for example, any one or two or more of silicon, iron, nickel, chromium, indium, niobium, germanium, titanium, molybdenum, aluminum, phosphorus, gallium, bismuth, and the like as a constituent element in addition to tin, cobalt, and carbon. In addition to the tin cobalt carbon-containing material, a material containing tin, cobalt, iron, and carbon as constituent elements (tin cobalt iron carbon-containing material) may be included.

In addition, the negative electrode material may be any one kind or two or more kinds among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Furthermore, a negative electrode conductive agent may be included in the negative electrode material layer to facilitate the transfer of electrons promoting the battery reaction. The binder that can be contained in the negative electrode material layer is not particularly limited, and examples of the binder include at least one selected from the group consisting of styrene-butadiene rubber, polyacrylic acid, polyvinylidene fluoride, polyimide-based resins, and polyamideimide-based resins. The negative electrode conductive agent that can be contained in the negative electrode material layer is not particularly limited, but examples thereof include at least one selected from carbon blacks such as thermal black, furnace black, channel black, ketjen black, and acetylene black, graphite, carbon fibers such as carbon nanotube and vapor-grown carbon fiber, metal powders such as copper, nickel, aluminum, and silver, and polyphenylene derivatives. Note that the negative electrode material layer may contain a component derived from a thickener component (for example, a carboxymethyl cellulose) used during battery production.

The positive electrode current collector and the negative electrode current collector used in the positive electrode 13 and the negative electrode 14 are members that contribute to collecting and supplying electrons generated in the electrode active material due to the battery reaction. Such an electrode current collector may be a sheet-shaped metal member. The electrode current collector may have a single layer or multiple layers. Furthermore, the electrode current collector may have a porous or perforated form. For example, the current collector may be a metal foil, a punching metal, a net, an expanded metal, or the like. For example, the positive electrode current collector that is used for the positive electrode 13 may be made of a metal foil containing at least one selected from the group consisting of aluminum, nickel, stainless steel, and the like. Meanwhile, for example, the negative electrode current collector used for the negative electrode 14 may be made of a metal foil containing at least one selected from the group consisting of copper, aluminum, nickel, stainless steel, and the like.

The separator 15 used in the positive electrode 13 and the negative electrode 14 is a member provided from the viewpoint of preventing a short circuit due to contact between the positive electrode and the negative electrode and maintaining the electrolyte. In other words, the separator 15 is a member that isolates the positive electrode 13 and the negative electrode 14 from each other, and allows ions (for example, lithium ions) to pass therethrough while preventing a short circuit of current due to contact between both electrodes. For example, the separator 15 may be a porous or microporous insulating member, which may have a membrane form due to its small thickness.

The separator 15 may be, for example, any one or two or more of porous membranes such as synthetic resin and/or ceramic, and may be a laminated membrane of two or more porous membranes. The synthetic resin used for the separator 15 is, for example, polytetrafluoroethylene, polypropylene, polyethylene, and the like. For example, the separator May include a porous membrane (base material layer) and a polymer compound layer provided on one surface or both surfaces of the base material layer. Since the adhesion of the separator 15 to the positive electrode 13 can be improved and the adhesion of the separator 15 to the negative electrode 14 can be improved, the distortion of the wound electrode body is easily suppressed. The polymer compound layer contains, for example, any one or two or more types of polymer compounds such as polyvinylidene fluoride. Excellent physical strength and electrochemical stability can be easily obtained. For example, the polymer compound layer may contain any one or two or more types of insulating particles such as an inorganic particle. Examples of the kind of inorganic particles include aluminum oxide and/or aluminum nitride. In the first embodiment, the separator is not particularly limited by its name, and may be a solid electrolyte, a gel-like electrolyte, and/or an insulating inorganic particle having a similar function.

As the electrolyte, typically, the electrolytic solution contains a solvent and an electrolyte salt. The electrolytic solution may further contain any one or two or more of other materials such as additives. In a preferred mode, the separator may be impregnated with the electrolytic solution, and the positive electrode 13 and/or the negative electrode 14 may also be impregnated with the electrolytic solution.

The solvent may contain any one or two or more of non-aqueous solvents such as organic solvents. The electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile). This is because more excellent battery capacity, cycle characteristics, and/or storage characteristics can be easily obtained. Examples of the cyclic carbonate ester include ethylene carbonate, propylene carbonate, and/or butylene carbonate. Examples of the chain carbonate ester include dimethyl carbonate, diethyl carbonate, ethyl methyl carbonate, and/or methyl propyl carbonate. Examples of the lactone include γ-butyrolactone and/or γ-valerolactone. Examples of the chain carboxylate ester include methyl acetate, ethyl acetate, methyl propionate, ethyl propionate, methyl butyrate, methyl isobutyrate, methyl trimethylacetate, and/or ethyl trimethylacetate. Examples of the nitrile include acetonitrile, methoxyacetonitrile, and/or 3-methoxypropionitrile. Examples of the non-aqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. In particular, the non-aqueous solvent preferably contains one or two or more of ethylene carbonate, propylene carbonate, dimethyl carbonate, diethyl carbonate, ethyl methyl carbonate, and the like. This is because higher battery capacity, more excellent cycle characteristics, and/or more excellent storage characteristics can be easily obtained. In addition, examples of the non-aqueous solvent include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This is because chemical stability of the electrolytic solution is easily improved. The “unsaturated cyclic carbonate ester” as used herein is a cyclic carbonate ester having one or two or more unsaturated bonds (carbon-carbon double bonds or carbon-carbon triple bonds). Examples of the unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. When the halogenated carbonate ester contains two or more halogens as a constituent element, the kind of the two or more halogens may be one kind or two or more kinds. Examples of the cyclic halogenated carbonate esters include 4-fluoro-1,3-dioxolan-2-one and/or 4,5-difluoro-1,3-dioxolan-2-one. Examples of the chain halogenated carbonate esters include fluoromethyl methyl carbonate, bis(fluoromethyl) carbonate, and/or difluoromethyl methyl carbonate. Examples of the sulfonate ester include a monosulfonate ester and/or a disulfonate ester. The monosulfonate ester may be a cyclic monosulfonate ester or a chain monosulfonate ester. Examples of the cyclic monosulfonate ester include sultones such as 1,3-propane sultone and/or 1,3-propene sultone. Examples of the chain monosulfonate ester include a compound in which a cyclic monosulfonate ester is cleaved in the middle. The disulfonate ester may be a cyclic disulfonate ester or a chain disulfonate ester. Examples of the acid anhydride include carboxylic anhydrides, disulfonic anhydrides, and/or carboxylic sulfonic anhydrides. Examples of the carboxylic anhydride include succinic anhydride, glutaric anhydride, and/or maleic anhydride. Examples of the disulfonic anhydride include ethanedisulfonic anhydride and/or propanedisulfonic anhydride. Examples of the carboxylic sulfonic anhydrides include anhydrous sulfobenzoic acid, anhydrous sulfopropionic acid, and/or anhydrous sulfobutyric acid. Examples of the dinitrile compound include a compound represented by NC—R1-CN (R1 is an alkylene group or an arylene group). Examples of the dinitrile compound include succinonitrile (NC—C₂H₄—CN), glutaronitrile (NC—C₃H₆—CN), adiponitrile (NC—C₄H₈—CN), and phthalonitrile (NC—C₆H₄—CN). Examples of the diisocyanate compound include a compound represented by OCN—R2-NCO (R2 is an alkylene group or an arylene group). Examples of the diisocyanate compound include hexamethylene diisocyanate (OCN—C₆H₁₂—NCO). Examples of the phosphate ester include trimethyl phosphate and triethyl phosphate. The chain compound having a carbon-carbon triple bond is a chain compound having one or two or more carbon-carbon triple bonds (—C≡C—). Examples of the chain compound having a carbon-carbon triple bond include propargyl methyl carbonate (CH≡C—CH₂—O—C(═O)—O—CH₃) and propargyl methyl sulfonate (CH≡C—CH₂—O—S(═O)₂—CH₃).

For example, the electrolyte salt included in the electrolytic solution may include any one or two or more of salts such as a lithium salt. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more excellent battery capacity, cycle characteristics, and/or storage characteristics can be easily obtained. Among them, one or two or more of lithium hexafluorophosphate, lithium tetrafluoroborate, lithium perchlorate, and lithium hexafluoroarsenate may be used.

A positive electrode lead 161 is connected to the end of the positive electrode 13 of the wound body and a negative electrode lead 162 is connected to the end of the negative electrode 14 of the wound body to take out a terminal outside the battery element 10.

The element fixing portion 17 is located on the side surface of the battery element 10 and fixes the end of the electrode constituting layer having a wound structure. Accordingly, the element fixing portion 17 prevents loosening or relaxing of the electrode constituting layer.

The exterior body (battery can) 20 corresponds to a member enclosing the electrode assembly 10 in which the electrode constituting layer including the positive electrode 13, the negative electrode 14, and the separator 15 is stacked. The battery can 20 may have, for example, a hollow structure in which one end portion is closed and the other end portion (open end portion) is opened. The battery can 20 is not particularly limited, but may be a metal can containing any one or two or more of metal materials such as iron, aluminum, stainless steel, and alloys thereof. For example, any one or two or more of metal materials such as nickel may be plated on the surface of the battery can.

The method for producing the battery 1 of the present disclosure will be exemplarily described with reference to the method for producing the battery 1 as an example. The battery 1 of the first embodiment can be produced, for example, by the following procedure.

For producing the positive electrode 13, the positive electrode active material is mixed as necessary with the positive electrode binder, the positive electrode conductive agent, and the like to obtain a positive electrode mixture. Next, the positive electrode mixture is dispersed in an organic solvent or the like to obtain a paste-like positive electrode mixture slurry. Then, the positive electrode mixture slurry is applied to one side or both sides of the positive electrode current collector, and the positive electrode mixture slurry is dried to form a positive electrode active material layer. Thereafter, if necessary, the positive electrode active material layer may be compression-molded using a roll press machine or the like. In such a case, the positive electrode active material layer may be heated, or may be repeatedly compression-molded two or more times. In the same manner, the negative electrode 14 can be produced. Specifically, the negative electrode active material, the negative electrode binder, the negative electrode conductive agent, and the like are mixed to obtain a negative electrode mixture. Subsequently, the negative electrode mixture is dispersed in an organic solvent or the like to obtain a paste-like negative electrode mixture slurry. Next, the negative electrode mixture slurry is applied to one side or both sides of the negative electrode current collector, and then the negative electrode mixture slurry is dried to form a negative electrode active material layer. Thereafter, if necessary, the negative electrode active material layer is compression-molded using a roll press machine or the like.

The metal plate is deep-drawn in multiple stages (at least two stages) to form the exterior body 20. For example, as illustrated in the upper view of FIG. 5, the punch 31 having an outer diameter φ₂ and the punch 32 having an outer diameter φ₁ are used to perform deep drawing in multiple stages. Thus, a space having the first inner diameter φ₁ and the second inner diameter φ₂ is formed in the exterior body 20.

When the battery 1 is assembled, a positive electrode lead is connected to the positive electrode current collector by a welding method or the like, and a negative electrode lead is connected to the negative electrode current collector by a welding method or the like. Next, the positive electrode 13 and the negative electrode 14 are stacked with the separator 15 interposed therebetween, and then the positive electrode 13, the negative electrode 14, and the separator 15 are wound to form a wound electrode body. Next, the center pin is inserted into the winding space of the wound electrode body. Then, while the wound electrode body is sandwiched between a pair of insulating plates, the wound electrode body is housed inside the exterior body together with the pair of insulating plates. In this case, one end portion of the positive electrode lead is connected to the external terminal by a welding method or the like, and one end portion of the negative electrode lead is similarly connected to the exterior body 20 by a welding method or the like. Next, the electrolytic solution is injected into the exterior body 20, and the wound electrode body is impregnated with the electrolytic solution. Finally, one end of the exterior body 20 is sealed. Thus, the battery 1 is completed.

The battery of a second embodiment is different from the battery 1 of the first embodiment in terms of electrical connection with the battery element 10. In other words, the battery of the second embodiment is different from the battery 1 of the first embodiment in that the battery of the second embodiment does not have leads (positive electrode lead and negative electrode lead), but extends the current collector to take out a terminal with a current collecting plate to the outside of the battery element 10. Hereinafter, this different configuration will be described in further detail according to an embodiment. In the second embodiment, the same reference numerals as those of the first embodiment denote the same configurations as those of the first embodiment, and thus the description thereof will be generally omitted.

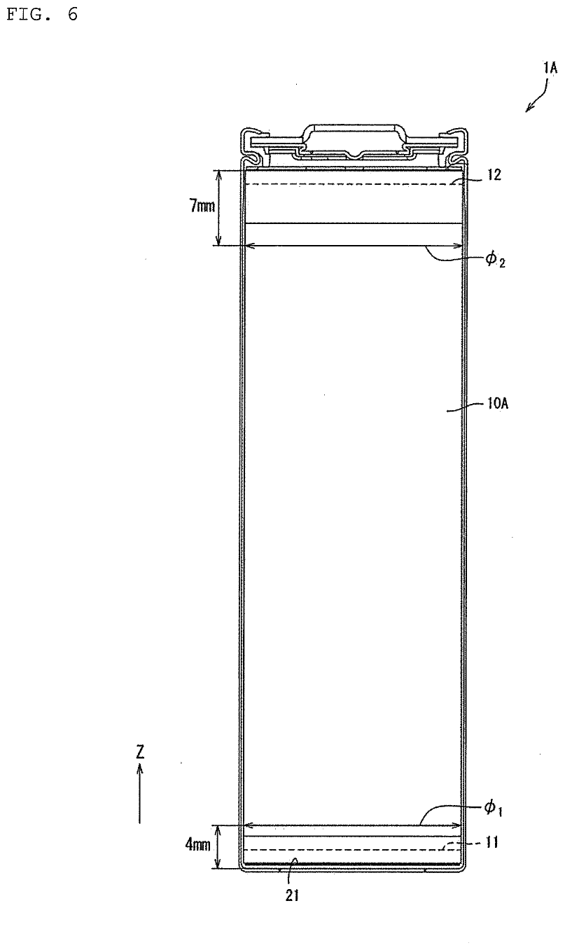

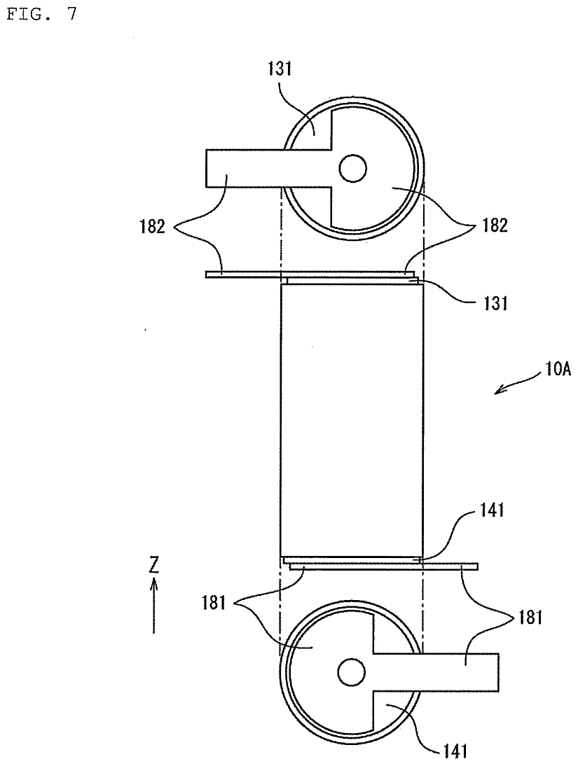

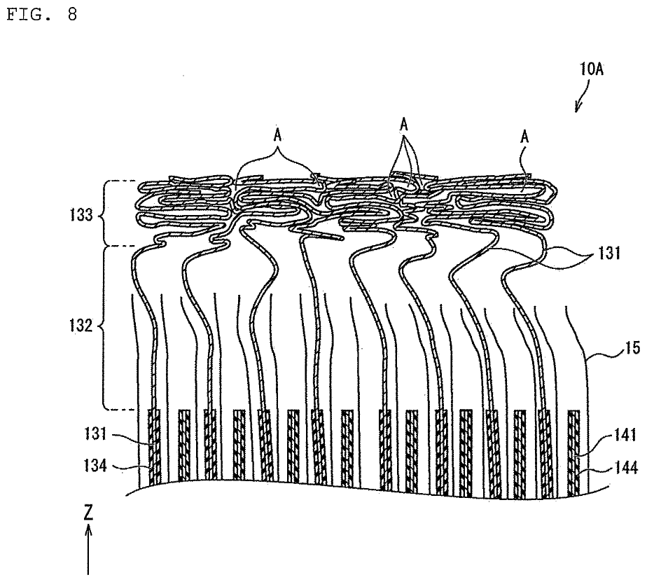

Hereinafter, the battery of the second embodiment will be described with reference to FIGS. 6, 7, and 8. FIG. 6 illustrates the battery of the second embodiment. FIG. 7 illustrates the battery element in the battery of the second embodiment. FIG. 8 illustrates the vicinity of the end of the battery element in the battery of the second embodiment.

In the battery 1A of the second embodiment, the battery element 10A further includes a negative electrode current collecting plate 181 and a positive electrode current collecting plate 182 as shown in FIG. 7. The negative electrode current collecting plate 181 and the positive electrode current collecting plate 182 are electrically connected to the electrode constituting layer via the current collectors. Through the negative electrode current collecting plate 181 and the positive electrode current collecting plate 182, the terminals are taken out to the outside of the battery element 10A.

Focusing on the connection mode between the positive electrode current collecting plate 182 and the positive electrode current collector 131, a plurality of the positive electrode current collectors 131 are extended and bundled in the vicinity of the first outer end surface 11 of the battery element 10A as shown in FIG. 8. The connection between the negative electrode current collecting plate 181 and the negative electrode current collector 141 is similar to the connection between the positive electrode current collecting plate 182 and the positive electrode current collector 131.

The extending portion 132 of the positive electrode current collector 131 forms a high density region 133 where the extending portions 132 are present at a high density. The current collecting plate (positive electrode current collecting plate 182 and negative electrode current collecting plate 181) is connected to the high density region 133 in a planar shape. That is, the extending portions 132 are bundled and electrically connected to the positive electrode current collecting plate 182. In the second embodiment, the positive electrode current collecting plate 182 constitutes the second outer end surface 12. In the battery 1 of the first embodiment, the lead has a linear structure and is linearly connected to the current collector at the end of the wound structure. Therefore, the battery 1A has a contact area larger than that of the battery 1 of the first embodiment, and can reduce the connection resistance.

Furthermore, since the wound body does not have a lead, the wound body has a structure closer to a perfect circle when viewed from the direction perpendicular to the battery axis. Therefore, the clearance between the inner side surface of the exterior body 20 and the outer peripheral surface of the battery element 10 is likely to be more uniform. As a result, the battery element 10 is easily fixed in the exterior body 20, and the vibration resistance is further improved.

In addition, the wound body has a structure closer to a perfect circle. Therefore, in the production of the battery 1A, the battery element 10 is more smoothly housed in the exterior body 20, and the defective rate is further reduced in battery production.

The battery of a third embodiment is different from the battery 1 of the first embodiment in the arrangement of the element fixing portion 17. Hereinafter, this different configuration will be mainly described. In the third embodiment, the same reference numerals as those of the first and second embodiments denote the same configurations as those of the first and second embodiments, and thus the description thereof will be generally omitted.

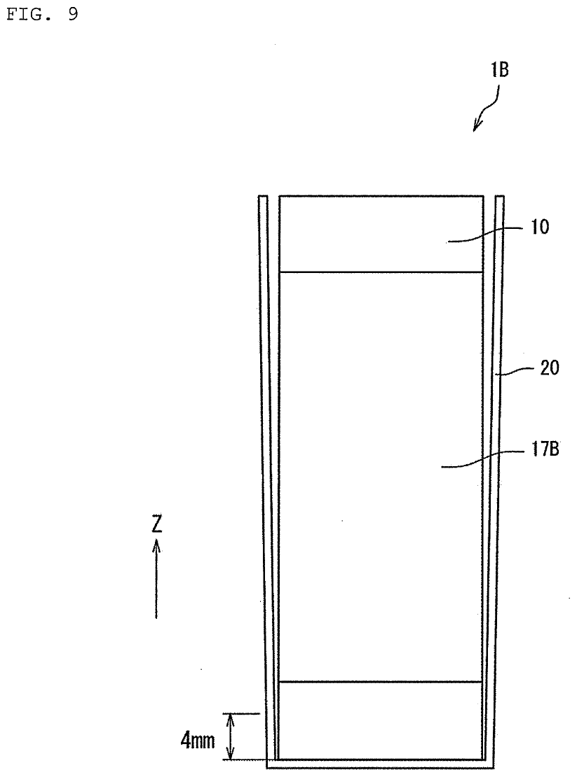

Hereinafter, the battery of the third embodiment will be described with reference to FIG. 9. FIG. 9 illustrates the battery element in the battery of the third embodiment.

In the battery element 10B of the battery 1B of the third embodiment, as shown in FIG. 9, the element fixing portion 17B is not arranged at the position 4 mm distant from the first inner end surface 21 toward the second outer end surface 12. That is, the lower end of the element fixing portion 17B is positioned in the forward Z direction from the position 4 mm distant from the first inner end surface toward the second outer end surface. The element fixing portion 17B is not arranged at the position 4 mm distant from the first inner end surface 21 toward the second outer end surface 12. Therefore, the position 4 mm distant from the first inner end surface 21 toward the second outer end surface 12 can be a region having the narrowest inner diameter in the exterior body 20. When the element fixing portion 17B is not arranged in the region, the vibration resistance of the battery element 10 is maintained in the exterior body 20, and the battery element 10 can be further smoothly housed in the exterior body 20 to further reduce the defective rate in the production of the battery 1B.

Although the embodiments of the present disclosure have been described above, the above-described embodiments are merely examples. The present disclosure is not limited to the above-described embodiments, and can be modified in design. In addition, the configurations in the first, second, and third embodiments may be variously combined.

For example, in the second embodiment, both the positive electrode 13 and the negative electrode 14 of the battery element 10 are taken out to the outside of the battery element 10 through the extending portion of the current collector, but the present disclosure is not limited thereto. Only one of the positive electrode and the negative electrode may be taken out by the extending portion of the current collector. In this case, the electrode having no extending portion of the current collector can have a lead.

The battery of the present disclosure is described in further detail as follows according to an embodiment.

<1>

A battery including: a battery element having a first outer end surface and a second outer end surface; and an exterior body having a cylindrical shape, having a first inner end surface to face the first outer end surface, and housing the battery element,
in which the exterior body has a first inner diameter φ₁ at a position 4 mm distant from the first inner end surface toward the second outer end surface; the exterior body has a second inner diameter φ₂ at a position 7 mm distant from the second outer end surface of the battery element toward the first outer end surface; and the first inner diameter φ₁ is 0.24 to 0.72% smaller than the second inner diameter φ₂.
   <2>

The battery according to <1>, wherein a difference between the first inner diameter φ₁ and the second inner diameter φ₂ (φ₂−φ₁) is 0.05 to 0.15 mm.

<3>

The battery according to <1> or <2>, wherein the battery element further has an element fixing portion on an outer peripheral surface of the battery element, and
the element fixing portion is not arranged at a position 4 mm distant from the first inner end surface toward the second outer end surface.
   <4>

The battery according to any one of <1> to <3>, wherein the battery element has a current collector having an extending portion, an electrode member layer laminated with the current collector, and an electrode current collecting plate constituting the first outer end surface and the second outer end surface, and
the extending portion is bundled and electrically connected to the electrode current collecting plate.
   <5>

The battery according to any one of <1> to <4>, wherein, in a sectional view parallel to a battery axis, the exterior body has a section that has at least one shape selected from a group consisting of a curved shape and a linear shape in at least a part of the section.

### EXAMPLES

The present disclosure will be described in further detail including with reference to Examples according to an embodiment. The present disclosure is not limited at all by the following Examples.

### Example 1

### [1. Preparation of Test Battery]

Prepared was a secondary battery having the following specifications. The configuration of Example 1 is summarized in Table 1.
Shape: cylindrical shape (diameter: about 22 cm, axial length: about 70 mm)
Positive electrode and negative electrode of electrode assembly: positive electrode and negative electrode that are capable of occluding and releasing lithium ions, and the electrode assembly has leads (positive electrode lead and negative electrode lead) arranged therein.

The embodiment in which the electrode assembly includes leads is described as “In-element current collection specification” in the column of “Tab structure specification” in Table 1.

The electrode assembly had a wound structure in which a plurality of sheets was wound, and the end portion of the wound structure was fixed with an element fixing tape (element fixing portion). The element fixing tape was not arranged at the position 4 mm distant from the bottom of the can (bottom of exterior body: first inner end surface) toward the second end surface. Such mode is described as “None” in the column of “Element fixing tape” in Table 1.
Nominal capacity: about 4100 mAh
Nominal voltage: 3.6 V
Inner diameter of exterior body: the inner diameter is constant in the range of within 4 mm from the first inner end surface
the inner diameter increases in the range of 4 mm to 10 mm along the battery axis
the inner diameter is constant in the range of 10 mm or more from the first inner end surface
Contact between inner peripheral surface of exterior body and outer peripheral surface of battery element: contact at least at the position of 4 mm from the first inner end surface

### (Material of Each Member)

Exterior body: made of metal (metal containing aluminum)

TABLE 1

| | [Configuration] | | | | | |
|---|---|---|---|---|---|---|
| | Inner diameter of exterior body | | | | Element | |
| | Mouth inner | Bottom inner | | | fixing | |
| | diameter | diameter | | | tape | |
| | (Second inner | (First inner | | | (Element | |
| | diameter φ₂) | diameter φ₁) | | | fixing | |
| | (mm) | (mm) | | | portion) | |
| | 7 mm from | 4 mm from can | | | 4 mm from | |
| | second outer | bottom (first | | | can bottom | |
| | end surface of | inner end surface | | | toward | |
| | battery element | of exterior body) | Difference | Ratio | second | |
| | toward first | toward second | (φ₂ − φ₁) | [(φ₂ − φ₁)/φ₂] | outer end | Tab structure |
| | end surface | outer end surface | (mm) | (%) | surface | specification |
| Example 1 | 20.80 | 20.75 | 0.050 | 0.24 | None | In-element |
| | | | | | | current |
| | | | | | | collection |
| Example 2 | 20.80 | 20.70 | 0.100 | 0.48 | None | In-element |
| | | | | | | current |
| | | | | | | collection |
| Example 3 | 20.80 | 20.65 | 0.150 | 0.72 | None | In-element |
| | | | | | | current |
| | | | | | | collection |
| Example 4 | 20.80 | 20.70 | 0.100 | 0.48 | Present | In-element |
| | | | | | | current |
| | | | | | | collection |
| Example 5 | 20.80 | 20.70 | 0.100 | 0.48 | None | Current |
| | | | | | | collector |
| Comparative | 20.80 | 20.80 | 0.000 | 0.00 | Present | In-element |
| Example 1 | | | | | | current |
| | | | | | | collection |
| Comparative | 20.80 | 20.78 | 0.020 | 0.10 | None | In-element |
| Example 2 | | | | | | current |
| | | | | | | collection |

[Effects]

Defective assembly rate

| | |
|---|---|
| Vibration test | Element insertion |

| | Pass rate | | defective rate | |
|---|---|---|---|---|
| | (%) | Evaluation | (ppm) | Evaluation |
| Example 1 | 90 | A | 1000 | A |
| Example 2 | 95 | A | 1500 | A |
| Example 3 | 100 | A | 2000 | A |
| Example 4 | 97 | A | 2000 | A |
| Example 5 | 97 | A | 500 | A |
| Comparative | 85 | B | 500 | A |
| Example 1 | | | | |
| Comparative | 88 | B | 700 | A |
| Example 2 | | | | |

### [2. Evaluation Method]

### (2-1. Vibration Test)

The vibration test was performed under normal temperature and normal pressure (23±2° C., 1 atm) in accordance with the UN38.3 standard.

The battery of Example 1, which was 10% thinner than the element system standard for battery elements, was fully discharged. Specifically, the battery was discharged to a constant voltage of 2.5 V at a temperature of 23±2° C. and a constant current of 4.0 A.

The electric resistance value (AC resistance value) of the discharged battery was measured using a battery tester (“Battery Tester 3561” manufactured by HIOKI E.E. CORPORATION, AC voltmeter) (the number of measurements n=1000). Specifically, an AC constant current having a measurement frequency of 1 kHz was applied, and the voltage value was measured. The internal resistance value of the battery was calculated from the obtained voltage value. The average value of a plurality of internal resistance values was calculated, and the obtained average value was defined as “Electric resistance value before applying vibration”.

Sweep type vibration was applied to the discharged battery. Specifically, the sweep was applied at a frequency of 7 Hz (minimum value)→200 Hz (maximum value)→7 Hz (minimum value) over 15 minutes. With the frequency change as one cycle, the cycle was performed 12 times for each of the three directions: XYZ axes (XYZ axes shown in FIG. 1). The amplitude was 0.8 (mm). For the battery applied with the vibrations, the electric resistance value was measured (number of measurements n=1000). The average value of a plurality of electric resistance values was calculated, and the obtained average value was defined as “Electric resistance value after applying vibration”.

From the obtained electric resistance values before and after applying vibration, the increase rate of electric resistance value due to applied vibration was calculated using the equation represented by (1):

$$Increase rate of electric resistance ( \% ) = [ ( Electric resistance value after applying vibration - Electric resistance value before applying vibration ) / Electric resistance value before applying vibration ] \times 100 \qquad ( 1 )$$

Based on the increase rate of electric resistance value, the vibration resistance of the battery of Example 1 was evaluated according to the following evaluation criteria. The evaluation results of the vibration resistance are summarized in Table 1.

### [Evaluation Criteria]

A (Pass: Good): the increase rate of electric resistance value is less than 10%

B (Fail: Bad): the increase rate of electric resistance value is 10% or more

### (2-2. Reduction of Defective Assembly)

In the production of the battery of Example 1, the battery element was housed in a cylindrical exterior body having an opening on the first end surface side such that the first outer end surface was faced to the vertically lower side. The housed battery element was observed in an image. Then, it was determined whether or not the second end surface of the battery element protrudes from the first opening end of the exterior body. The protrusions were counted for the measurements of n=100,000. (2):

The equation represented by (2): Defective assembly rate (ppm)=(Number of protrusions/Number of measurements n)×10⁶ was used to calculate the defective assembly rate (element insertion defective rate). Based on the defective assembly rate, the battery of Example 1 was evaluated for reduction in defective assembly in the following evaluation results. The evaluation results on reduction in defective assembly are summarized in Table 1.

### [Evaluation Criteria]

A (Pass: Good): the defective assembly rate is less than 2500 ppm

B (Fail: Bad): the defective assembly rate is 2500 ppm or more

### Examples 2 to 5 and Comparative Examples 1 to 2

### [1. Preparation of Test Battery]

Test batteries were prepared in the same manner as in Example 1 except that the battery configuration was changed to the configuration shown in Table 1. Specifically, the inner diameter ratio was changed in Examples 2 to 5 and Comparative Examples 1 to 2.

In Example 4 and Comparative Example 1, the element fixing tape (battery element fixing portion) on the outer surface of the battery element was arranged at the position 4 mm distant from the bottom of the can (first inner end surface of exterior body) toward the second outer end surface. Such mode is described as “Present” in the column of “Element fixing tape” in Table 1.

In Example 5, a current collector specification without a lead in the electrode assembly was adopted. In the current collector specification, for each of the positive electrode and the negative electrode, the extending portions of the current collectors were bundled to form a high density region and electrically connected to the current collecting plate.

### [2. Evaluation]

For the batteries of Examples 2 to 5 and Comparative Examples 1 to 2, the vibration test and the defective assembly rate were performed in the same manner as in Example 1. Table 1 shows the evaluation results.

### Results: Examples 1 to 5 and Comparative Examples 1 to 2

As shown in Table 1, in the batteries of Examples 1 to 5, the first inner diameter of the exterior body was 0.24 to 0.72% smaller than the second inner diameter thereof. For the vibration test for the batteries of Examples 1 to 5, all the results were A (Pass).

On the other hand, as shown in Table 1, in the batteries of Comparative Examples 1 to 2, the first inner diameter of the exterior body was less than 0.24% or more than 0.72% smaller than the second inner diameter thereof. For the vibration test for the batteries of Comparative Examples 1 to 2, all the results were B (Fail).

From the above, it is apparent that the batteries of Examples 1 to 5 have further improved vibration resistance as compared with Comparative Examples 1 to 2.

Note that the effects and the like of the above Examples are merely an example. Therefore, the present disclosure is not limited to the above matters, and may have additional effects.

### INDUSTRIAL APPLICABILITY

The battery according to the present disclosure (a battery such as a primary battery and a secondary battery) can be typically used for applications in which use of electric energy is required. For example, the (secondary) battery according to the present disclosure can be used in various fields in which power storage is assumed. Although it is merely an example, the (secondary) battery of the present disclosure can be used in the fields of electricity, information, and communication in which electric and electronic equipment and the like are used (for example, electric and electronic equipment fields or mobile equipment fields including mobile phones, smartphones, notebook computers and digital cameras, activity meters, arm computers, electronic papers, and wearable devices, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (for example, the fields of hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a battery element having a first outer end surface and a second outer end surface; and
an exterior body having a cylindrical shape, having a first inner end surface to face the first outer end surface, and housing the battery element,
wherein the exterior body has a first inner diameter φ₁ at a position 4 mm distant from the first inner end surface toward the second outer end surface,
the exterior body has a second inner diameter φ₂ at a position 7 mm distant from the second outer end surface of the battery element toward the first outer end surface, and
the first inner diameter φ₁ is 0.24 to 0.72% smaller than the second inner diameter φ₂.

2. The battery according to claim 1, wherein a difference between the first inner diameter φ₁ and the second inner diameter φ₂ (φ₂−φ₁) is 0.05 to 0.15 mm.

3. The battery according to claim 1,
wherein the battery element further has an element fixing portion on an outer peripheral surface of the battery element, and
the element fixing portion is not arranged at a position 4 mm distant from the first inner end surface toward the second outer end surface.

4. The battery according to claim 1,
wherein the battery element has a current collector having an extending portion, an electrode member layer laminated with the current collector, and an electrode current collecting plate constituting the first outer end surface and the second outer end surface, and
the extending portion is bundled and electrically connected to the electrode current collecting plate.

5. The battery according to claim 1, wherein, in a sectional view parallel to a battery axis, the exterior body has a section that has at least one shape selected from a group consisting of a curved shape and a linear shape in at least a part of the section.
